(19) United States
(12) Patent Application Publication
(10) Pub. No.: US 2005/0246324 A1
(43) Pub. Date: Nov. 3, 2005

(54) System and associated device, method, and computer program product for performing metadata-based searches

(75) Inventors: Joonas Paalasmaa, Jarvenpaa (FI); Antti Sorvari, Itasalmi (FI); Jukka-Pekka Salmenkaita, Espoo (FI)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Nokia Inc.

(21) Appl. No.: 10/836,764

(22) Filed: Apr. 30, 2004

(51) Int. Cl. G06F 7/00

(52) U.S. Cl. 707/3

(57) ABSTRACT

Provided are improve data search and management systems, devices, methods, and computer program products for performing metadata-based searches and displaying the initial results as clusters depending upon search criteria, search results, or physical limitations of a device such as a display. Using clusters provides an intuitive way of displaying results on a compact device with a small screen and limited user interface.

### FIELD OF THE INVENTION

The present invention relates generally to systems and methods for searching data files and, more particularly, to systems and associated devices, methods, and computer program products for performing metadata-based searches of data files using a small display and a limited user interface.

### BACKGROUND

Mobile devices, including mobile communication devices and terminals, and wireless communication technologies have advanced significantly over the recent few decades. In keeping stride with the advancement and impact of mobile devices, new wireless systems, devices, protocols, and services are developed and introduced to further the use of these technologies, and consumers continue to demand even more advanced wireless functionality and capabilities. Such technologies far surpass simply allowing voice communications and include, for example, text messaging, multimedia messaging and communications, e-mail, Internet browsing, music, and access to a wide range of wireless applications and services. Recent systems, including third generation (3G) systems, such as those specified for use with the Global System for Mobile communications (GSM) wireless standard, enable the delivery of new digital services not previously available or prohibitively inefficient in earlier second generation (2G) wireless networks.

These improved technologies also present the need for increased processor capacity and storage for the increasing amounts of data that may now be transmitted to a mobile device. Mobile devices have improved as storage devices, and mobile devices now provide increased storage capacity for data files such as email, email attachments, web pages, images, music, and other files such as multimedia files which can be transmitted on 3G systems. Improved storage devices and increased storage capacities also result in increasing numbers of data files. As the number of data files on a mobile device increase, accessing a particular data file or group of data files becomes increasingly difficult, less efficient, and, eventually, prohibitive for effective use of the mobile device as a storage medium.

This problem is particularly relevant for devices with small display screens such as mobile telephones, MP3 players, personal digital assistants, and devices that represent a combination of these and other personal and wireless technologies. Because of growing storage capacities, even devices with small screens that traditionally had limited storage capacities can, nevertheless, contain large quantities of data and numbers of data files, such as media files or media items. In addition to the problem of small displays, physical and software user interfaces are typically limited on many personal and wireless devices. If the physical user interface is not going to change, the manner of using the device and associated software user interface can be changed to improve the ability to manage increasing amounts of stored data.

Example previous and existing file management systems have relied upon folder-based management with searching or filtering based upon data file characteristics such as name, date, type, and size. Other approaches have taken advantage of searching metadata fields of data files. But these file management systems rely primarily upon presenting search results in a flat list such as the flat list of results shown in FIG. 1. The depiction in FIG. 1 merely provides a user the ability to see a listing of data files appearing in a folder or resulting from a search. The user would have to scroll through the list to identify a particular data file even if the list included numerous data files. A flat list is incapable of efficiently presenting results of data files using a small screen, limited user interface, or a combination of physical and interface limitations, particularly where large quantities of data and numbers of data files are stored on a device. Existing file management systems do not provide users with the ability to adequately identify, locate, and select a particular data file, whether for emailing or sending to another device or user, deleting the file, listening or watching the file, or any other use or activity. For example, a mobile telephone or other terminal with a built in digital camera presents a users with the practical difficulty of managing large numbers of digital images or other media files, such as movies and sound. Finding a particular image from hundreds of images that were captured or otherwise stored on a mobile device is very difficult.

### SUMMARY

In light of the foregoing background, embodiments of the present invention provide an improved system and associated terminal, method, and computer program product for performing metadata-based searches of data files using a small display and a limited user interface.

Embodiments of the present invention improve upon existing data search and management systems by displaying the initial results of a search, or filter, as clusters depending upon the type of matches or filtered items that result. Using clusters provides an intuitive way of displaying results on a compact device with a small screen and limited user interface. Embodiments of the present invention also provide a user the ability to refine a search, the results of a search, and the clusters that are produced to organize and present the results.

Embodiments of the present invention provide a system, associated device or mobile terminal, method, and computer program product for performing metadata-based searches. An embodiment of a system of the present invention may include a memory for storing data files with associated metadata and a processor for searching the metadata files, producing results with hits associated with the search, clustering the results based upon the metadata, and displaying the clustered results. The results and clustered results can be refined by further searching of the data files or the results and clustered results. An embodiment of a system of the present invention may also include an input device and a display. The input device may be used to enter search criteria such as characters, character strings, and search operators.

An embodiment of a mobile terminal of the present invention may include a memory and processor similar to the previously described system embodiment and may also include a search application for operating on the processor based upon character input from an input device and providing the results and clustered results to a display of the mobile terminal.

An embodiment of a method of the present invention may include the steps of searching metadata associated with data files based upon search criteria character input to produce search results and clustering the search results to produce result clusters. The character input may be a single character, a character string, combinations of characters and character strings, or multiple character strings. Characters and character strings are defined herein to include any character, symbol, or other representative unit, including spaces, such as characters typically found on a keyboard or alphanumeric keypad or identified as ASCII, but is not limited to alphanumeric characters. A character string may be a single character if the character string is a separate search criteria from another character or character string, such as “n” and “jun” in FIG. 6. Search criteria character input may also include search operators such as a space representing an AND or an OR operator. Various additional or alternative search operators may be included in the search criteria character input. The clustering of the results to produce result clusters may be based upon character input such as character strings of the search criteria. As additional characters are inputted to further define search criteria, the results and result clusters may be refined after the additional character or characters have been input. The result clusters may be displayed, and, after selecting one of the result clusters, the results of a selected result cluster may be displayed. The displayed results may then be further searched or filtered using similar methods to produce the result clusters for traditional searching capabilities.

In an embodiment of a method of the present invention where results are clustered, the clustering may be performed based upon a predetermined display capability such as the ability to show a particular number of results or result clusters on a display device. The clustering of results may alternatively or additionally be based upon the metadata of the search results. The metadata may provide clustering based upon, for example, a period of time, an event, or a topic of the metadata or based upon a physical location of data files in the search results. Clustering may also or alternatively be based upon a predetermined maximum result cluster size, meaning the number of results that are included in a result cluster or a maximum percentage or a combination of percentage or number of results that are included in a result cluster. Clustering may also or alternatively be based upon relevancy to search criteria, such as the number of hits of search criteria in each of the search results. In addition to clustering, results and result clusters may be ordered for display such as by relevancy to search criteria, alphabetical listing, a period of time, a date, time stamp, a sender, a creator, an owner, an event, a topic, a location, or the relevant weight of a data file or a number of data files.

An embodiment of a computer program product of the present invention is also provided that includes metadata searching for results using result clusters to organize the search results that would otherwise be displayed in a flat result list. As described with reference to embodiments of methods of the present invention, embodiments of computer program products of the present invention include the ability to accept additional search criteria character input to refine search results and result clusters that are displayed. These characteristics, as well as additional details, of the present invention are further described herein with reference to these and other embodiments.

### BRIEF DESCRIPTION OF THE DRAWING(S)

Having thus described the invention in general terms, reference will now be made to the accompanying drawings, which are not necessarily drawn to scale, and wherein:

FIG. 1 is prior art flat listing of data files;

FIG. 2 is a display on a mobile terminal showing search results of a textual metadata-based search of data files according to an embodiment of the present invention;

FIG. 3 is a display on a mobile terminal showing search results of a date metadata-based search of data files according to an embodiment of the present invention;

FIG. 4 is a display on a mobile terminal showing search results of a single character metadata-based search of data files according to an embodiment of the present invention;

FIG. 5 is a display on a mobile terminal showing a view of a result cluster of a metadata-based search of data files according to an embodiment of the present invention;

FIG. 6 is a display on a mobile terminal showing search results of a single character and character string combination metadata-based search of data files according to an embodiment of the present invention;

FIG. 7 is a display on a mobile terminal showing search results of a single character and three character strings combination metadata-based search of data files according to an embodiment of the present invention;

FIG. 8 is a block diagram of a multilevel result cluster for a metadata-based search of data files according to an embodiment of the present invention;

FIG. 9 is a flowchart and diagram of a metadata-based search of data files according to an embodiment of the present invention; and

FIG. 10 is a block diagram of a computer system of an embodiment of the present invention for performing metadata-based searches.

### DETAILED DESCRIPTION

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

While a primary use of the present invention may be in the field of mobile phone technology, it will be appreciated from the following description that the invention is also useful for many types of devices that are generally referenced herein as mobile terminals, including, for example, handheld data terminals and personal data assistants, portable medical devices, personal multimedia units such as video or audio players (e.g., MP3 players), handheld PC devices, digital cameras, digital camcorders, portable TV devices, computer watches, and other portable electronics, including devices that are combinations of the aforementioned devices. Similarly, one of ordinary skill in the art will recognize that, while the present invention is particularly useful for devices with small screens and limited physical user interfaces, the present invention can be used for searching or managing data files on other devices and systems.

One aspect of the present invention is the use of metadata in searches to determine or partially determine search results. As used herein, metadata means both the traditional data identified as metadata fields in data files such as description field and tagged information and also traditional non-metadata field information such as a file name, time stamp, and other information related to the data file, including a log of actions that are related to or that have been applied to the file, whether included as part of the data file or stored separately such as in an external database. Metadata is intended to mean the collective total of all information associated with the data file. For example, an image data file would include an image but the metadata related to the file would also include all other information related to the image, including metadata stored in the data file such as EXIF or IPTC fields inside a JPEG image file. Further, metadata may include text include in a data file such as a multimedia message where a sender provides text explaining where and attached image was captured; similar location metadata may be stored in metadata fields associated with the attached image data file. By way of further explanation and example, an image data file may have associated metadata including a file name, file size, date and time, description, image resolution and size, image type, and copyright information separate and apart from the image itself.

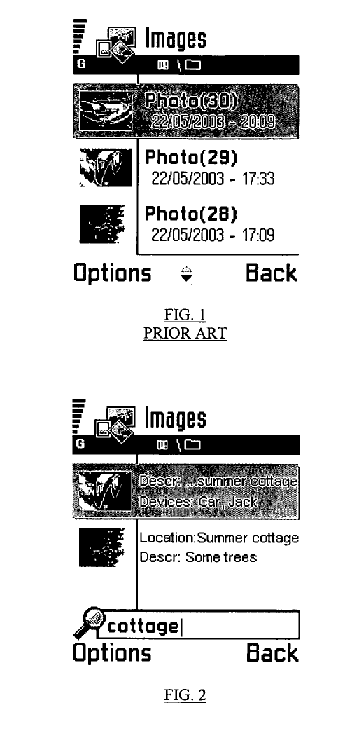

A second aspect of the present invention is the use of clustering of search results to further refine and improve the efficiency of searching and the provisioning of the results of the search, particularly on devices with small displays and limited user interfaces. With respect to the metadata-based searching aspect of embodiments of the present invention, FIG. 2 is a display on a mobile terminal showing search results of a textual metadata-based search of data files according to an embodiment of the present invention. In FIG. 2, image data files are searched or filtered for occurrences of a character string representing the search criteria. Specifically, the word “cottage” has been entered in the search field, as denoted by the rectangular box in the lower portion of the display, and used to search the metadata of the image files. Only the two image files with occurrences of “cottage” in the metadata of the image files are displayed. FIGS. 2-3 and 5 show exemplary flat lists of data file results of metadata-based searches. FIGS. 4, 6, and 7 show exemplary lists of result clusters of metadata-based searches, further evidenced by the stacked appearance of the representative result cluster thumbnail images or icons. In FIG. 2, because a particular search criteria character string has been used to search or filter the images, the matching images are displayed in a manner such that the hits or occurrences of the search criteria are displayed. These hits may be displayed in a manner to emphasize or accentuate the search criteria, such as by highlighting the hit in a different color of font or a different colored background or combination thereof. Because of limited display size, only certain metadata fields may be visible. In the embodiment of FIG. 2, the priority of displayed metadata fields are based upon the metadata fields with matching search criteria occurrences, and extractions thereof. For example, in FIG. 2, extractions of metadata information for the resulting image files from the description, devices, and location metadata fields. The metadata fields that appear first for each result, description and location, include occurrences of search criteria. This type of a display structure is particularly useful when a thumbnail or representative image or icon of a data file may be used rather than file name or other non-identifying or limited identification name of a data file. Described in more detail with reference to FIGS. 4, 6, and 7, the results and metadata occurrences may be updated as each character of the search criteria input. Typically, this style of metadata searching, where a search field is used to enter search criteria to begin a search, may be initiated from a flat list of displayed images, meaning a list of all of the files in a single dimension of a particular storage unit, such as an entire memory or a particular folder on a memory.

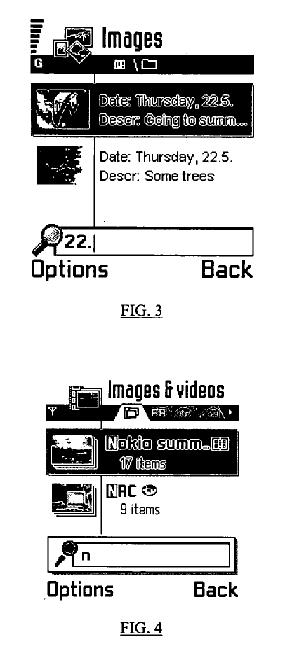

In addition to textual metadata search criteria, characters and character strings may represent any type of metadata associated with data files. Search criteria may be defined by character input such as characters, character strings, and operators to search any type of metadata field such as a textural description, keywords, location, periods of time, dates, time, sender, creator, owner, events, topics, and weights of activity of data files. For example, FIG. 3 is a display on a mobile terminal showing search results of a date metadata-based search of data files according to the embodiment of the present invention. Search criteria may also be based upon available storage location of data files such as from nearby and accessible Bluetooth (BT) devices. Just as various metadata fields may be searched, the format search criteria may be any type and still be searched within a metadata field. For example, in the example embodiment of FIG. 3, all date formats can be used to match with the data fields. For example, if a user types “August” the search algorithm or routine may be configured to search not only for the word “August” or an abbreviation such as “Aug.” but also for date formats including numerical representations of the month of August, such as a date format of 8 or 08. One of ordinary skill in the art will recognize that the present invention may include various advantageous characteristics of existing search engines and search routines apart from the additional features of the present invention of a metadata-based search and result clustering. One of ordinary skill in the art will also recognize that character input may be by any number of input devices, including numeric and alphanumeric keypads; motion sensitive input devices such as mice, touchpads, joysticks, and directional buttons, keys, and touchpads; and voice input devices such as microphones. Thus, character input is not limiting of the type of input device which may be used to provide search criteria.

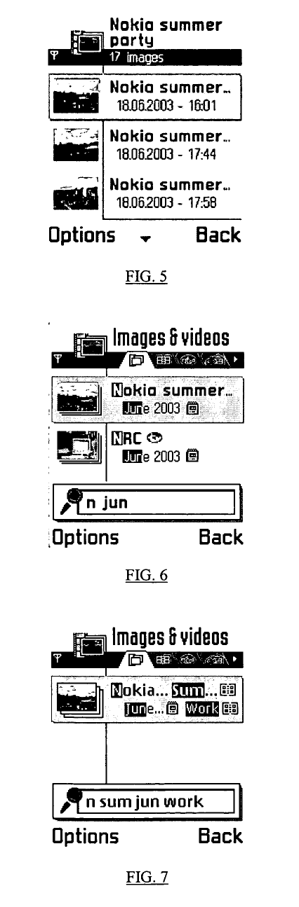

As previously mentioned, search criteria may be a single character as represented in FIG. 4. As one of ordinary skill in the art will recognize, a search routine may be configured to search for any occurrence of a single character in metadata or only occurrences beginning with the single character. The example embodiment of the present invention shown in FIG. 4 comprises the latter of these two possibilities whereby the search routine identifies only occurrences in the metadata where the first character of a character string, such as a word, matches the search criteria character. As a user continues to type additional search criteria characters, character strings, or operators, the search routine may update the results and/or the result clusters based upon the additional search criteria to present only the result or result clusters that conform to the search criteria that has been entered. For example, FIGS. 6 and 7 represent searches that include additional search criteria such as character strings.

Search results may be organized or clustered into result clusters, as described further herein. A user may select or open a result cluster to display the data files or results which have been organized or grouped into the result cluster. For example, FIG. 5 is a display on a mobile terminal showing a content of a result cluster of a metadata-based search of data files according to the embodiment of the present invention. The results of the data cluster of FIG. 5 correspond generally to the first result cluster identified in FIGS. 4, 6, and 7. This result cluster is selected and shown in flat list view in FIG. 5 from the highlighted result cluster shown in FIGS. 4, 6, and 7. If a flat list of a selected result cluster or representation of the result clusters do not adequately limit the number of data files that have been identified, a user may continue to type additional search criteria characters, character strings, or operators to further refine or limit the search results of a selected result cluster. Alternatively, an entirely new search criteria may be established to refine the results of a result cluster or additional or alternative search criteria may be entered to refine the original result clusters that were identified prior to selection of the result cluster as in FIG. 5. When refining a search of a result list or result clusters, an additional feature identified such as by an option entitled “refined search” may be selected to clear the search criteria to begin a new search, but preserving the current list or result clusters that have been identified to effectively serve as the entire dataset for the refined search. For example, if a selected result cluster includes ten data files, a refined search, such as using a pop-up search feature, may be restricted to a search of the ten data files in the selected result cluster rather than potentially all of the data files or all of the search results.

One of ordinary skill in the art will identify that search criteria may include search operators such as a space character that indicates an AND or an OR operator between search criteria characters and/or character strings. Any search operator may be used. For example, AND, +, OR, NOT, −, LIKE, ˜, PRE/n, W/n, W/M, ATLEAST/n/X, “,”, “;”, !, *, #, and ?. As for any operator, any search operation may be assigned or configured. However, by way of example, the following example operators are further defined with example meanings: + may mean inclusive similar to AND, − may be exclusive similar to NOT, LIKE and ˜ may identify synonyms or similar character strings, PRE/n may be used where a first search criteria character string proceeds a second search criteria character string by not more than n characters or character strings, W/n may be used where search terms are within n characters or character strings of each other, W/M may be used where search terms are in the same metadata field, ATLEAST/n/X may be used where search term X appears at least n times in the metadata of a data file, a “,” (comma) or a “;” may be used as an AND or an OR operator, ! may mean an exact match, * may represent a placeholder for any single or multiple character beginning or ending or may be used with a root word plus all the words made by adding letters to the beginning or end, # may represent a placeholder for any single character, and, as with any other symbol or operator, ? may be assigned to as any desired operator.

A search may be configured in a routine or by operation of a user to search all of the characters and/or character strings throughout all of the metadata fields of associated data files. Alternatively, search criteria may be separated by operators such as space characters or commas to search or focus on different metadata fields or alternatively this function may be defined in a general options. For example, a first search criteria keyword may be searched through all of the metadata fields for occurrences, and a second keyword may be searched through all of the remaining metadata fields in which the first search criteria keyword did not appear. Effectively, each search criteria may identify a particular metadata field or group of metadata fields. For example, a user may want to identify data files with associated metadata where two search terms appear in two different metadata fields. A user can enter two search terms, and if this type of search is being used, the search routine will only identify data files where the two search terms appear in two different metadata fields of a data file. In such a manner, a user may be able to aggressively refine the search results in result clusters in order to quickly identify a particular data file or group of data files. In one alternate embodiment of the present invention, a search may also be restricted to contain only a certain file type, selected file types, or all file types, where types may be defined by a particular category such as images or music, a particular file extension such as .gif or .jpg, or any other file type scheme. One of ordinary skill in the art will recognize that file types may be used to cluster and/or order results of a search, as described further herein.

One of ordinary skill in the art will recognize that embodiments of the present invention may search a composite data file as a single file and as separate files, only as a single file, or only as separate files. Some media files can be combined together into composite productions, or more general media items. For example, a composite media file such as a MMS message may include text, video, audio, images, web pages, other media files, and combinations of these and other media files. A search may identify matches within the composite media file and/or the separate files and include as results of the search the composite media file and separate files, only as the single composite media file, or only as the separate files. If only the single composite media file will be represented as a result, an embodiment of the present invention may search the composite media item as if it has inherited the metadata of the data files composed therein. One of ordinary skill in the art will also recognize that certain combinations of media items may be interpreted as metadata of other media items. For example, a composite media item of text, such as a greeting message, and an image, such as a holiday picture, may be interpreted so that the text part of the media item is inherited or annotated as metadata of the image.

As previously described, matches or occurrences in metadata fields of search criteria may be displayed as hits associated with results and result clusters in result lists and result cluster lists. The number of data files that match a particular selection of a result cluster or search criteria, may be displayed for each result cluster and/or each list. For example, the number of identified result clusters may be indicated and the number of results in a result cluster may be indicated. Further, thumbnails or icons may be used to further identify the results and result clusters in a list. The example embodiments of FIGS. 2-7 each include thumbnail images of the first item or the item with highest weighted activity that appears in each result cluster or a thumbnail of the result data file. The user experience with result lists and result cluster lists may be further improved using highlighting or emphasis of occurrences and matches of search criteria in result clusters or metadata of results. One of ordinary skill in the art will recognize that search results and hits may not be limited to represent only strict matches to the search criteria, but that any number of modified searching routines may be used to identify variants or associated matches to the search criteria. For example, results and/or hits may include data files and metadata that are similar to the express search criteria yet not exact matches. Further, one of ordinary skill in the art will recognize that such variant results and/or hits may be used to cluster, as described further herein, the search results such as where a separate result cluster is formed with variant results rather than results based upon exact matches to the search criteria.

In addition to searching by metadata associated with data files, embodiments of the present invention provide for grouping or ordering of search results into result clusters, or clustering. For example, a multi-dimensional metadata-structure or “categorization scheme” related to all of the matched data files may be analyzed by a clustering routine to determine alternative views or clusters to present the resulting data files from a metadata search. The multi-dimensional metadata-structure relates to the plurality of metadata fields which may be identified as having matches or occurrences of search criteria. This plurality of metadata fields forms a multi-dimensional metadata-structure. The resulting data files may be prioritized or grouped based upon occurrences in similar metadata fields or related multi-dimensional metadata-structure of the resulting data files. A view may be, for example, combinations of time, date, and periods of time parameters into a single cluster. Similarly, event and topic metadata field occurrences may be clustered. However, one of ordinary skill in the art will recognize that clusters may be organized to represent resulting data files based upon any number of characteristics and metadata fields. Additional example metadata categories or clusters may include metadata fields or combinations of metadata fields such as time, location, events, topics, time-location, time-event, time-topic, event-location, and relevancy to search criteria. For example, if a search string of “August” matches data files from both August 2002 and August 2003, the data file matches may be clustered into two groups representative of their files for August 2002 and data files for August 2003. Search results may also be clustered based upon metadata that may not be part of the search criteria or not found but is otherwise represented in the resulting files. For example, the results from a search string of “August” may be clustered based upon location metadata information such as “summer cottage,” “office,” and “home.” One of ordinary skill in the art will recognize the various alternative clustering methods may also be utilized for grouping search results of embodiments of the present invention. Further, clusters may be identified or named using search criteria keywords or occurrences of search criteria in metadata fields.

A clustering routine may be configured to organize a limited number of clusters that contain only a representative selection of data files including a high density of search criteria among all of the results from a search, discarding less relevant data files or data files with low density of search criteria in the data file metadata. Clustering of results may also be based upon the search criteria that is entered. For example, result clusters may be organized to show all of the results from one search criteria character string in a single result cluster and all of the result clusters from a second search criteria character string in a second result cluster. A third result cluster may be representative of all of the data files with occurrences of both character strings.

Embodiments of the present invention may also include result clusters that contain extended search results and/or hits, meaning results and/or hits that do not strictly meet the search criteria but have similar metadata as the actual search results and/or hits. Actual search results and/or hits means search results and/or hits representative of exact matches to the search criteria. Extended search results and/or hits may be clustered to be presented separately from actual search results and/or hits or sorted to be secondary to actual search results and/or hits. Searching for results and/or hits similar to but not exact matches to the search criteria may be useful when metadata may be incomplete. For example, if a user searches a specific period or moment in time, such as a day, and a keyword, such as “in-laws,” to find a picture of the new in-laws of the user taken on the wedding day of the user, the matched results could include a first data file picture having both search criteria, a second data file being the previous picture captured as indicated by time metadata, and a third data file being the next picture captured as indicated by time metadata. Similarly, clusters may be formed of data files matching a period of time, or other characteristic, closely related to the search criteria such as data file captured one hour before or one hour after a searched hour. Another example may be where a first cluster includes exact matches to the search criteria and a second cluster includes similar but not exact matches such as the day of the search criteria but not the time of the search criteria. A further example, may be where the search routine has been configured to look for synonyms and plurals of search criteria such as where a search for brown also results in matches of tan and beige.

Clustering criteria may also or alternatively include considerations of limitations of a display such as the size or resolution of the display to limit the number of result clusters to the number capable of being displayed or a number of result clusters not significantly greater than the number of result clusters that may be displayed, such as twice or three times the display capability. For example, a user interface of a mobile device may be physically small in size, have a low resolution, or a combination of both such that the display may also present a limited amount of information without requiring scrolling. Depending upon the size or resolution of a display, a search routine or a clustering routine may be configured to provide for example two to six data files or result clusters. Thumbnails, icons, and text or metadata information such as occurrences of search criteria in the metadata may be presented with the limited number of results or result clusters. Parameters of a thumbnail image or icon may further limit the amount of information that may be displayed on a mobile device. All of this information may be taken into consideration by a search routine or a clustering routine to provide result lists and result cluster lists that are easily navigable by a user and present information in an efficient manner. For example, the embodiments of FIGS. 2 through 7 display a maximum result list or result cluster list of three results or result clusters, but FIG. 5 includes an arrow indicating a scrolling feature to view additional results not visible due to the limited display capabilities. Embodiments of the present invention may also determine that clustering is not required if only a limited number of results is identified from the search criteria.

Once result clusters have been determined and populated with search results, the result clusters may be displayed to a user indicating various characteristics of the result cluster such as the number of results in the cluster, hits of search criteria in the metadata, and representative thumbnails or icons of results in the result cluster. Additionally, icons describing different metadata fields may be displayed. As previously described, a user may then select a result cluster to review the results in the cluster, further search the result clusters, or refine the entire search while preserving the identified result clusters and results.

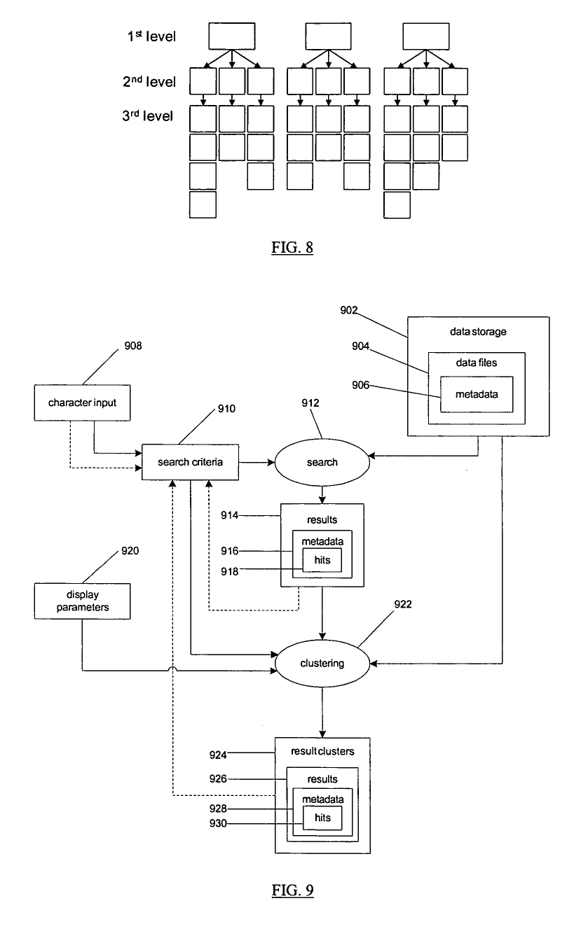

If large numbers of result data files or result clusters are organized, embodiments of the present invention may perform multilevel clustering. FIG. 8 is a block diagram of a multilevel result cluster and results for a metadata-based search of data files according to an embodiment of the present invention. A broad first level of result clusters may be representative of a second level of result clusters for each of the first level result clusters. These second level result clusters may include data file results that are of limited number such that they may be easily displayed and managed on a mobile device. The use of multilevel clustering may be automated as part of the clustering routine or may be selected or deselected by user operation. If multilevel clustering is performed, a user may be informed of the number of or existence of sublevels and the total number of images in a first level or higher order level result cluster. One of ordinary skill in the art will recognize that multilevel clustering may include the selection of the number of levels for grouping and ordering the results in result clusters. For example, a user may be able to perform an initial search that results in a large number of resulting data files and/or result clusters. A user may then determine that multilevel clustering would be beneficial and select two level multilevel clustering such as in FIG. 8. Alternatively, the user may determine that three level or four level multilevel clustering would be advantageous. Alternatively, after selecting two level multilevel clustering, a user may be able to then determine that a third level of multilevel clustering would be advantageous. A user may also be able to decrease the number of multilevel clustering, for example, by decreasing from three levels to two levels of result clusters.

One of ordinary skill in the art will recognize that the result clusters and data file results of result clusters may be organized or sorted according to different criteria. For example, the alphabetical name of the result data files or the level provided for a result cluster may be used to organize the list. Alternative organization criteria may include such characteristics as the relevancy to search criteria, periods of time, dates, times, sender, creator, owner, events, topics, locations, and weighted activity of data files. Any number of metadata fields or characteristics of data files may be used to order results and result clusters. The weighted activity of a data file is intended to describe quantity characteristics of a data file such as the number of times a data file has been accessed, displayed, emailed or sent, printed, or edited. Relevancy to search criteria may include any number of characteristics such as the quantity or number of occurrences of search criteria in metadata fields, the number of metadata fields in which the search criteria occurs, and various other traditional search relevancy determinations.

One of ordinary skill in the art will recognize that text on nine keys (T9) can be used to improve the efficiency of searching of embodiments of the present invention. T9 is a system that allows users to enter words and phrases by pressing a number key for each letter in the word or phrase. The system is similar to entering the letters of a name when looking up someone in a company's phone directory over a phone. T9 was developed as a faster alternative to multi-tapping, a text input system that requires the user to tap a key from two to four times to select many letters. In contrast, T9 uses predictive text input and predictive software to enable identification of a letter with a single key tap. T9 compares the single key tap input to a list of possible words in dictionary. According to embodiments of the present invention, a specific dictionary containing all of the words that occur in metadata of the data files on a storage device, or metadata that appears in search results, may be compiled for use with a T9 system. If the T9 system is not able to take advantage of or is not able to identify hits or words within this limited metadata dictionary, the T9 system may fall back to a standard or default dictionary. When using a T9 system, a separate dialogue or input box may be opened and used on the display of a mobile device for inputting a character string such as a word or phrase and/or search operators using the T9 system, and then, after the T9 system has been used to input search criteria, that inputted search criteria may be selected as search criteria for the metadata-based search. One of ordinary skill in the art will also recognize that various other functionalities for searching may be used such as speech recognition. Additional technologies may also utilize a compiled metadata dictionary such as to improve the recognition accuracy of speech recognition.

One of ordinary skill in the art will also recognize that embodiments of the present invention may be used for other applications apart from mobile devices such as searching on the Internet. The dynamic searching and clustering and refinement of searching and clustering may be used for other applications such as messaging or email and media such as music and video files. Embodiments of the present invention provide additional features for various management applications of multiple data files. For example, in a messaging or email system, messages may be searched based upon the various characteristics or metadata of the emails such as title or subject, sending, recipient, date, and message body to search and cluster the messages that would be otherwise searched and provided in a resulting flat list of messages. In general, the present invention may be utilized to manage and search any type or kind of file.

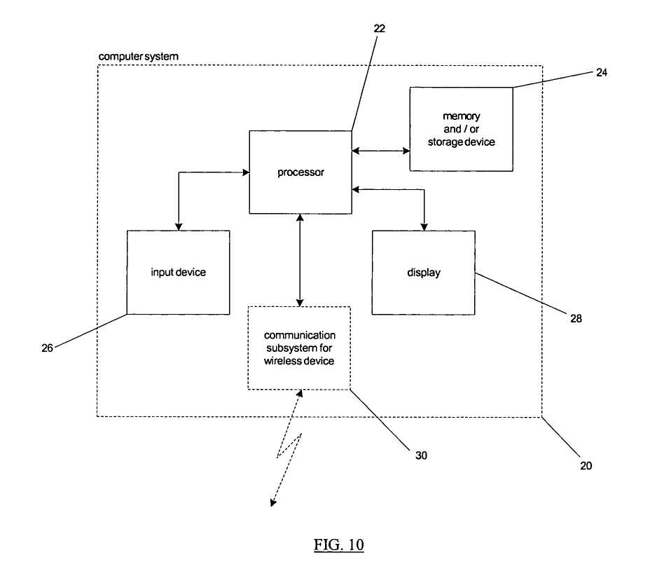

FIG. 9 is a flowchart and diagram of a metadata-based search of data files according to embodiment of the present invention. A data storage or memory device 902, such as random access memory (RAM), a hard drive, or other fixed data memory or storage device, may include numerous data files 904 each with associated metadata 906. Character input 908 may be used to create search criteria 910, such as characters, character strings, and/or search operators, that is combined with the data files 904 and metadata 906 from the data storage 902 to perform a search 912. Based upon these search criteria 910 and the metadata 906 of the associated data files 904, results 914 are provided from the search 912. The resulting data files 914 include associated resulting metadata 916 and metadata result hits 918 representative of matches or occurrences of search criteria 910 identified in the search 912. The results 914 are then clustered from a clustering routine 922 that takes advantage of any number of clustering criteria such as information from the data storage 902, the original or additional search criteria 910, the results 914, the metadata 916 of the results, the hits 918 of the results 914, and display parameters 920. Result clusters 924 are provided from the clustering routine 922. The result clusters 924 include results 926 with associated metadata 928 and representative hits 930. As previously described, a user may refine the results 914, result clusters 924, and/or results 926 of the result clusters 924 by repeating the steps of searching 912 and/or clustering 922.

One of ordinary skill in the art will also recognize that the present invention may be incorporated into software systems and subsystems, as well as various other applications. In each of these systems as well as other systems, including dedicated systems, capable of hosting the system and method of the present invention as described above, the system generally can include a computer system including one or more processors that are capable of operating under software control to provide the metadata-based searching and clustering techniques described above.

As shown in FIG. 10, the present invention may be embodied by or include a computer system 20 embodied by a mobile terminal. In this regard, such a computer system may include at least one processing element, such as a processor 22 or central processing unit, manipulating computer program software, such as a search routine that may implement any of the search techniques described above and a clustering routine that may implement any of the clustering techniques described above, and data, such as data files and associated metadata, stored by memory and/or a storage device 24. The processor may receive input from an input device 26 and may display information on a display 28. Where the computer system 20 is a wireless device such as a mobile communication terminal, the processor 22 may operate with a communication subsystem 30. One or more processors, memory, storage devices, and other computer elements may be used in common by a computer system and subsystems, as part of the same platform, or processors may be distributed between a computer system and subsystems, as parts of multiple platforms.

It will be understood that each block, or step, or element of the flowchart of FIG. 9, and combinations of blocks and/or elements in the flowchart, support combinations of means and combinations of steps for performing the specified functions. Similarly, it will be understood that each block, or step, or element of the flowchart of FIG. 9, and combinations of blocks and/or elements in the flowchart, can be implemented by computer program instructions as noted above. These computer program instructions may be loaded onto a computer or other programmable apparatus to produce a machine, such that the instructions which execute on the computer or other programmable apparatus create means for implementing the functions specified in the flowchart block(s) or element(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowchart block(s) or element(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the flowchart block(s) or element(s). It will also be understood that each block or element of the flowchart, and combinations of blocks and/or elements in the flowchart, can be implemented by special purpose hardware-based computer systems which perform the specified functions or steps, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A system for performing metadata-based searching, comprising:
a memory capable of storing data files and associated metadata; and
a processor interoperably coupled to said memory and capable of searching said metadata to produce results with associated metadata, clustering said results based upon metadata of said results, and displaying said clustered results.

2. The system of claim 1, wherein said processor is further capable of refining at least one of said results and said clustered results.

3. The system of claim 1, wherein said processor is capable of clustering said results based upon at least one of a period of time, a sender, a creator, an owner, an event, a topic, a date, a time, a location, relevancy to search criteria, or display capability.

4. The system of claim 1, further comprising an input device coupled to said processor.

5. The system of claim 1, further comprising a display coupled to said processor.

6. A mobile terminal, comprising:
a memory for storage of data files with associated metadata;
a processor interoperably coupled to said memory;
an input device for inputting characters and interoperably coupled to said processor;
a search application interoperably coupled to said processor and capable of accepting said character input to perform a metadata-based search for results and capable of clustering said results; and
a display interoperably coupled to said processor and capable of displaying said clustered results.

7. The mobile terminal of claim 6, wherein said search application is further capable of clustering said results based at least in part upon said metadata.

8. The mobile terminal of claim 7, wherein said search application is capable of clustering said results based upon at least one of a period of time, a sender, a creator, an owner, an event, a topic, a date, a time, a location, relevancy to search criteria, or display capability.

9. The mobile terminal of claim 7, wherein said search application is capable of clustering said results in at least two levels of result clusters.

10. The mobile terminal of claim 6, wherein said search application is further capable of refining at least one of said results and said clustering based upon additional character input using said input device.

11. A method of performing metadata-based searching, comprising the steps of:
searching metadata associated with data files based upon search criteria character input to produce search results; and
clustering said search results to produce result clusters.

12. The method of claim 11, wherein said character input comprises at least two characters of the same character string.

13. The method of claim 11, wherein said character input comprises at least two character strings.

14. The method of claim 13, wherein said character input further comprises at least a space or an operator.

15. The method of claim 14, wherein said space is an AND operator or an OR operator.

16. The method of claim 14, wherein said operator is selected from the group of: AND, +, OR, NOT, −, LIKE, ˜, PRE/n, W/n, W/M, ATLEAST/n/X, “,”, “;”, !, *, #, and ?.

17. The method of claim 12, wherein said step of clustering said search results comprises the step of grouping said results based upon character strings of said search criteria.

18. The method of claim 11, further comprising the step of refining said search results after each character input.

19. The method of claim 11, further comprising the step of displaying said result clusters.

20. The method of claim 19, further comprising the steps of:
selecting at least one result cluster; and
displaying the results of said selected result cluster.

21. The method of claim 20, further comprising the step of searching said results of said selected result cluster.

22. The method of claim 11, wherein said step of clustering said search results comprises the steps of:
predetermining a display capability for said results and said result clusters; and
grouping said results based upon said predetermined display capability.

23. The method of claim 22, wherein said step of predetermining a display capability is at least based upon one of an intended display size and an intended display resolution of said results and said result clusters.

24. The method of claim 11, wherein said step of clustering said search results comprises the step of grouping said results based upon metadata in said search results.

25. The method of claim 24, wherein said step of grouping said results is further based upon at least one of a period of time, a sender, a creator, an owner, an event, a topic, or a location in said metadata of said results.

26. The method of claim 25, wherein said period of time is selected from the group of: a second, a minute, an hour, a day, a week, a month, a year, a decade, and a predetermined date range.

27. The method of claim 11, wherein said step of clustering said search results comprises the steps of:
predetermining a maximum result cluster size for said result clusters; and
grouping said results based upon said predetermined maximum result cluster size.

28. The method of claim 11, wherein said result clusters are organized in at least two levels of result clusters.

29. The method of claim 11, wherein said step of clustering said search results comprises the step of grouping said results based upon relevancy to said search criteria.

30. The method of claim 11, further comprising the step of ordering said result clusters.

31. The method of claim 30, wherein said step of ordering said result clusters is at least based upon one of the characteristics selected from the group of: relevancy to said search criteria, alphabetical, period of time, date, time, event, topic, and location.

32. The method of claim 11, further comprising the step of ordering said results in at least one of said result clusters.

33. The method of claim 32, wherein said step of ordering said results in at least one of said result clusters is at least based upon one of the characteristics selected from the group of: relevancy to said search criteria, alphabetical, period of time, date, time, sender, creator, owner, event, topic, location, and weight of data file.

34. The method of claim 33, wherein said weight of data file is based at least upon one of the quantities selected from the group of: number of times data files of said results have been accessed, number of times data files of said results have been displayed, number of times data files of said results have been sent, number of times data files of said results have been printed, and number of times data files of said results have been edited.

35. A method of performing metadata-based searching on a mobile terminal, comprising:
searching metadata associated with data files based upon search criteria character input to said mobile terminal to produce search results;
clustering said search results based upon metadata of said search results to produce result clusters; and
displaying said result clusters on a display of said terminal.

36. The method of claim 35, further comprising the step of refining said search results after each character input.

37. The method of claim 35, further comprising the step of selecting clustering criteria for said step of clustering said search results.

38. The method of claim 35, wherein said result clusters are organized in at least two levels of result clusters.

39. The method of claim 35, wherein said step of clustering said search results is based at least upon the display capabilities of said display.

40. The method of claim 35, further comprising the steps of:
identifying hits of search criteria in metadata; and
displaying said hits for said result clusters.

41. The method of claim 35, further comprising the steps of:
a. inputting a first character search criteria;
b. displaying said result clusters to produce displayed result clusters;
c. inputting a second character search criteria; and
d. refining at least one of said search results and said result clusters and updating said displayed result clusters based upon said second character search criteria.

42. The method of claim 41, further comprising the step of repeating at least once the steps of:
inputting an additional character or character string search criteria; and
refining at least one of said search results and said result clusters and updating said displayed result clusters based upon said additional search criteria.

43. The method of claim 42, further comprising the step of selecting clustering criteria for said step of clustering said search results.

44. A computer program product comprising a computer-useable medium having control logic stored therein for performing metadata-based searching, said control logic comprising:
a data input code for accepting character input;
a metadata search code for searching metatdata of data files based upon character input;
a result output code for producing results from said metadata search code;
a clustering code for clustering said results of said result output code;
a display code for displaying result clusters of said clustering code;

45. The computer program product of claim 44, wherein said clustering code clustering said results based upon at least one of a period of time, a sender, a creator, an owner, an event, a topic, a date, a time, a location, relevancy to search criteria, or display capability.

46. The computer program product of claim 44, further comprising a refining code for refining at least one of said results and said result clusters based upon additional character input accepted by said data input code.

47. The computer program product of claim 44, further comprising a cluster selection code for selecting a result cluster and displaying results of said selected result cluster.

48. The computer program product of claim 47, wherein said display code displays hits of said character input associated with said results.

49. The computer program product of claim 47, further comprising a results searching code for searching said results of said selected result cluster.

50. The computer program product of claim 44, further comprising a display capability code for determining the display capability of a display device.

51. The computer program product of claim 50, wherein said clustering code clusters results of said metadata search code based at least in part upon said display capability.

52. The computer program product of claim 44, wherein said display code displays hits of said character input associated with said results or said result clusters.
